(19) United States
(12) Patent Application Publication
(10) Pub. No.: US 2009/0038013 A1
(43) Pub. Date: Feb. 5, 2009

(54) WIRELESS COMMUNICATION SECURITY WHEN USING KNOWN LINK KEYS

(75) Inventors: Christian Zechlin, Herne (DE); James Dent, Camberley (GB); Franck Maillot, Espoo (FI); Eugen Palnau, Dortmund (DE)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/831,324

(22) Filed: Jul. 31, 2007

(51) Int. Cl. G06F 11/30

(52) U.S. Cl. 726/25

(57) ABSTRACT

The present system may enhance security in device having a wireless interface while it is operating in a mode that may make it more vulnerable to predatory attacks. More specifically, the advent of certain development or support operating modes supported by particular wireless communication mediums, such as debug modes that allow other wireless devices to monitor messages coming and going from a wireless device for diagnostic purposes, may leave devices overly accessible while operating in such a mode. As a result, additional security measures are required in order to determine if a vulnerable mode should be enabled on a device, and further, whether another device should be allowed to establish a communication to a device operating in this mode.

### BACKGROUND OF THE INVENTION

1. Field of Invention

The present invention relates to securing communication in a wireless protocol, and more specifically, to a system for providing additional security for wireless communication devices when operating in a Debug mode that might leave these devices vulnerable to attack.

2. Background

More and more, the ability to communicate wirelessly is emerging as a popular feature to include in many devices where communication was previously not contemplated. This popularity may, at least in part, be fueled by rapid technological development in the area of multifunction wireless communication devices (WCD). Consumers may now replace common standalone productivity devices like computers, laptops, facsimile machines, personal digital assistants, etc. with singular devices capable of performing all of these functions. Devices with these abilities have been embraced by business people who often find that work can now be completed during time that was previously wasted (commutes to and from work, home, etc.)

However, greater ability may also create greater vulnerability. More specifically, wireless devices empowered to operate over various different wireless communication mediums in order to accomplish different tasks may unavoidably provide a means of “access” through which an operator with mischievous or malicious intentions may gain access to the device. For example, a device configured to allow connections from other wireless devices for the purpose of conveying information of interest to a user may also allow a third-party device to monitor the behavior of the user's device in order to gain vital security key information, or to directly gain access to the device in order to obtain personal and/or confidential information about a user.

This situation may be further exacerbated by new features included in emerging wireless communication mediums intended to improve the overall performance of the medium during development or “trouble-shooting” by a technical support person. Some monitoring or “debugging” operational modes now being included in the core design of these communication protocols are intended to be beneficial, but may instead become detrimental in the wrong hands. For example, a device operating in a debugging mode intended to allow diagnostic devices to monitor transactions to and from the device over a particular wireless communication medium may also open the device up to access from other third-party devices preying on the user/device. While the terms “debug” and “debugging mode” have been used to refer to the specific purpose of the previously described mode, the terms “debug” and “debugging mode” are used only for the sake of explanation, and are intended to include all modes that may have a reduced level of security as compared to other modes. Thus, the invention may also encompass modes that don't have diagnostic or similar purposes, but that have reduced security for this or any other purpose.

### SUMMARY OF THE INVENTION

The present invention, in accordance with at least one embodiment, includes at least a method, computer program, device and system for enhancing security in a device having a wireless interface operating in mode that may make it more vulnerable to predatory attacks. More specifically, the advent of particular wireless communication mediums supporting operating modes having lower security encryption, such as debug modes that allow other wireless devices to monitor messages coming and going from a wireless device for diagnostic purposes, may leave devices overly accessible while operating in such a mode. As a result, additional security measures may be required in order to determine if a vulnerable mode should be enabled on a device, and further, whether another device should be allowed to establish communication with a device operating in this mode.

In at least one embodiment of the present invention, wireless links utilizing debug access keys may be established between devices so that wireless transactions may be monitored for diagnostic purposes. The debug communication mode may deactivate security measures in the linked devices such as secret key encryption, and therefore, leave them open to attack. Therefore, before engaging in a communication link using unsecured debug keys, inquiries may be made in order to determine whether it is appropriate to enter this more vulnerable mode.

For example, an inquiry may determine whether a device that is being requested to enter a wireless link using debug access keys was already in a debug mode when the request to establish the link was made, and whether the duration of the debug mode has exceeded a preset time limit. Based on these inquiries, events may be triggered in the WCD to either allow or terminate certain device functionality. In another exemplary configuration of the present invention, one or more inquiries may be made directly to a device user in order to determine whether the device user will allow another device to connect while operating in a debug mode. Further, certain conditions such as cycling power in a WCD or the deactivation of a particular wireless communication medium in the WCD may automatically trigger the device to disconnect an active link that is using debug keys, deactivate a debug mode, purge debug access keys, etc.

In further examples of the present invention, two or more devices may initiate communicate over a wireless interface. A decision may then be made in a first device to enter a reduced security mode for continuing the communication already established between the devices, or which is about to be established between the devices. At least a second device may receive key information related to the change in communication in one or more messages from the first device. The key information may be, for example, an encryption key. At least the second device may then determine whether the key information includes key information related to a reduced security mode, and may further verify whether the second device is configured to allow communication in a reduced security mode. Depending on the outcome of the verification, the second device may trigger an event. For example, if the verification is positive, it may continue communication immediately or only after a user confirmation, and may later delete any stored keys related to the communication. On the other hand, a negative verification may result in communication being terminated, an inquiry to the user of the second device for permission to enter a reduced security mode, the deletion of any stored keys related to a recent (e.g. the most recent) reduced security communication, or any combination of these.

### DESCRIPTION OF DRAWINGS

The invention will be further understood from the following detailed description of a preferred embodiment, taken in conjunction with appended drawings, in which:

FIG. 1A discloses a modular description of an exemplary wireless communication device usable with at least one embodiment of the present invention.

FIG. 1B discloses an exemplary structural description of the wireless communication device previously described in FIG. 1A.

FIG. 2 discloses an exemplary wireless communication medium device pairing in accordance with at least one embodiment of the present invention.

FIG. 3A discloses an exemplary wireless communication medium device link establishment in accordance with at least one embodiment of the present invention.

FIG. 3B discloses an intervening device added to the transaction previously described in FIG. 3A in accordance with at least one embodiment of the present invention.

FIG. 4 discloses an exemplary Diffie-Hellman key exchange in accordance with at least one embodiment of the present invention.

FIG. 5 discloses an exemplary Diffie-Hellman key exchange in Debug mode in accordance with at least one embodiment of the present invention.

FIG. 6A discloses an exemplary security enhancement in accordance with at least one embodiment of the present invention.

FIG. 6B discloses another exemplary security enhancement in accordance with at least one embodiment of the present invention.

FIG. 6C discloses another exemplary security enhancement in accordance with at least one embodiment of the present invention.

FIG. 6D discloses another exemplary security enhancement in accordance with at least one embodiment of the present invention.

FIG. 6E discloses another exemplary security enhancement in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

### I. Wireless Communication Device

As previously described, the present invention may be implemented using a variety of wireless communication equipment. Therefore, it is important to understand the communication tools available to a user before exploring the present invention. For example, in the case of a cellular telephone or other handheld wireless devices, the integrated data handling capabilities of the device play an important role in facilitating transactions between the transmitting and receiving devices.

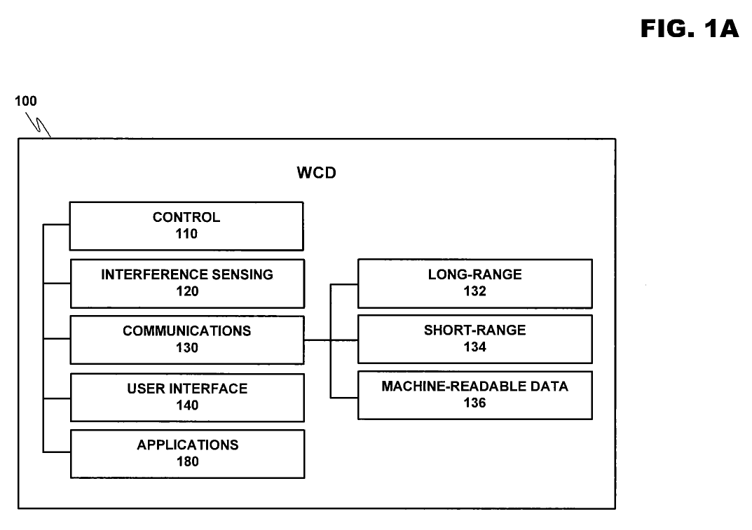

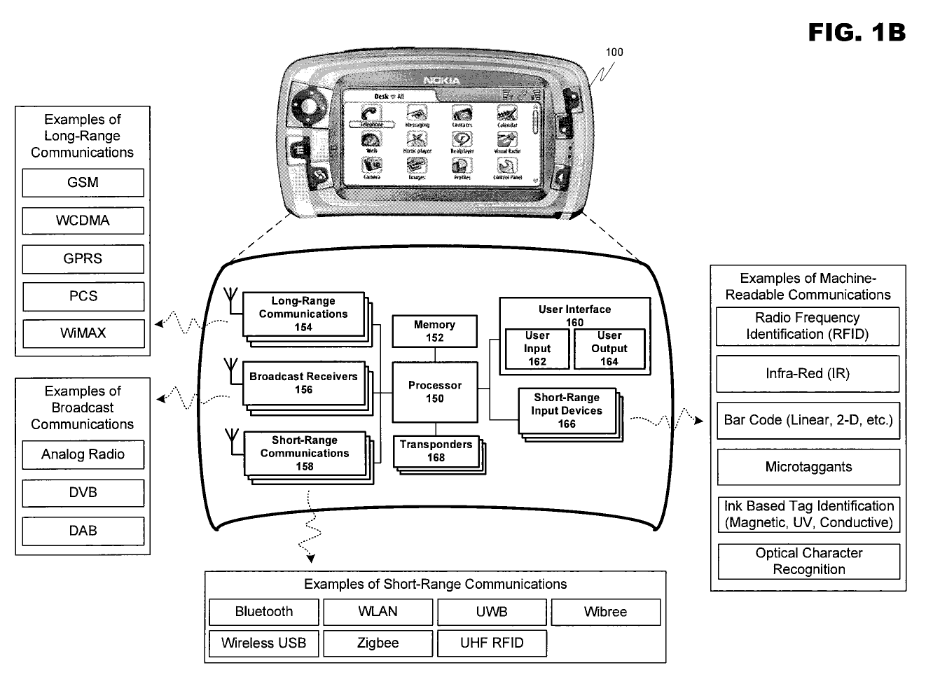

FIG. 1A discloses an exemplary modular layout for a wireless communication device usable with the present invention. WCD 100 is broken down into modules representing the functional aspects of the device. These functions may be performed by the various combinations of software and/or hardware components discussed below.

Control module 110 regulates the operation of the device. Inputs may be received from various other modules included within WCD 100. For example, interference sensing module 120 may use various techniques known in the art to sense sources of environmental interference within the effective transmission range of the wireless communication device. Control module 110 interprets these data inputs, and in response, may issue control commands to the other modules in WCD 100.

Communications module 130 incorporates all of the communication aspects of WCD 100. As shown in FIG. 1A, communications module 130 may include, for example, long-range communications module 132, short-range communications module 134 and machine-readable data module 136 (e.g., for NFC). Communications module 130 utilizes at least these sub-modules to receive a multitude of different types of communication from both local and long distance sources, and to transmit data to recipient devices within the transmission range of WCD 100. Communications module 130 may be triggered by control module 110, or by control resources local to the module responding to sensed messages, environmental influences and/or other devices in proximity to WCD 100.

User interface module 140 includes visual, audible and tactile elements which allow a user to receive data from, and enter data into, the device. The data entered by a user may be interpreted by control module 110 to affect the behavior of WCD 100. User-inputted data may also be transmitted by communications module 130 to other devices within effective transmission range. Other devices in transmission range may also send information to WCD 100 via communications module 130, and control module 110 may cause this information to be transferred to user interface module 140 for presentment to the user.

Applications module 180 incorporates all other hardware and/or software applications on WCD 100. These applications may include sensors, interfaces, utilities, interpreters, data applications, etc., and may be invoked by control module 110 to read information provided by the various modules and in turn supply information to requesting modules in WCD 100.

FIG. 1B discloses an exemplary structural layout of WCD 100 according to an embodiment of the present invention that may be used to implement the functionality of the modular system previously described in FIG. 1A. Processor 150 controls overall device operation. As shown in FIG. 1B, processor 150 is coupled to at least communications sections 154, 158 and 166. Processor 150 may be implemented with one or more microprocessors that are each capable of executing software instructions stored in memory 152.

Memory 152 may include random access memory (RAM), read only memory (ROM), and/or flash memory, and stores information in the form of data and software components (also referred to herein as modules). The data stored by memory 152 may be associated with particular software components. In addition, this data may be associated with databases, such as a bookmark database or a business database for scheduling, email, etc.

The software components stored by memory 152 include instructions that can be executed by processor 150. Various types of software components may be stored in memory 152. For instance, memory 152 may store software components that control the operation of communication sections 154, 158 and 166. Memory 152 may also store software components including a firewall, a service guide manager, a bookmark database, user interface manager, and any communication utilities modules required to support WCD 100.

Long-range communications 154 performs functions related to the exchange of information over large geographic areas (such as cellular networks) via an antenna. These long-range network technologies have commonly been divided by generations, starting in the late 1970s to early 1980s with first generation (1G) analog cellular telephones that provided baseline voice communication, to modern digital cellular telephones. GSM is an example of a widely employed 2G digital cellular network communicating in the 900 MHZ/1.8 GHZ bands in Europe and at 850 MHz and 1.9 GHZ in the United States. In addition to basic voice communication (e.g., via GSM), long-range communications 154 may operate to establish data communication sessions, such as General Packet Radio Service (GPRS) sessions and/or Universal Mobile Telecommunications System (UMTS) sessions. Also, long-range communications 154 may operate to transmit and receive messages, such as short messaging service (SMS) messages and/or multimedia messaging service (MMS) messages.

As a subset of long-range communications 154, or alternatively operating as an independent module separately connected to processor 150, transmission receiver 156 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 158 is responsible for functions involving the exchange of information across short-range wireless networks. As described above and depicted in FIG. 1B, examples of such short-range communications 158 are not limited to Bluetooth™, Wibree™, WLAN, UWB and Wireless USB connections. Accordingly, short-range communications 158 performs functions related to the establishment of short-range connections, as well as processing related to the transmission and reception of information via such connections.

Short-range input device 166, also depicted in FIG. 1B, may provide functionality related to the short-range scanning of machine-readable data (e.g., for NFC). For example, processor 150 may control short-range input device 166 to generate RF signals for activating an RFID transponder, and may in turn control the reception of signals from an RFID transponder. Other short-range scanning methods for reading machine-readable data that may be supported by short-range input device 166 are not limited to IR communication, linear and 2-D (e.g., quick response or QR) bar code readers (including processes related to interpreting universal product codes or UPC labels), and optical character recognition devices for reading magnetic, Ultraviolet (UV), conductive or other types of coded data that may be provided in a tag using suitable ink. In order for short-range input device 166 to scan the aforementioned types of machine-readable data, the input device may include optical detectors, magnetic detectors, CCDs or other sensors known in the art for interpreting machine-readable information.

As further shown in FIG. 1B, user interface 160 is also coupled to processor 150. User interface 160 facilitates the exchange of information with a user. FIG. 1B shows that user interface 160 includes a user input 162 and a user output 164. User input 162 may include one or more components that allow a user to input information. Examples of such components include keypads, touch screens, and microphones. User output 164 allows a user to receive information from the device. Thus, user output portion 164 may include various components, such as a display, light emitting diodes (LED), tactile emitters and one or more audio speakers. Exemplary displays include liquid crystal displays (LCDs), and other video displays.

WCD 100 may also include one or more transponders 168. This is essentially a passive device that may be programmed by processor 150 with information to be delivered in response to a scan from an outside source. For example, an RFID reader mounted in an entryway may continuously emit radio frequency waves. When a person with a device containing transponder 168 walks through the door, the transponder is energized and may respond with information identifying the device, the person, etc. In addition, a reader may be mounted (e.g., as discussed above with regard to examples of short-range input device 166) in WCD 100 so that it can read information from other transponders in the vicinity.

Hardware corresponding to communications sections 154, 156, 158 and 166 provide for the transmission and reception of signals. Accordingly, these portions may include components (e.g., electronics) that perform functions, such as modulation, demodulation, amplification, and filtering. These portions may be locally controlled, or controlled by processor 150 in accordance with software communication components stored in memory 152.

The elements shown in FIG. 1B may be constituted and coupled according to various techniques in order to produce the functionality described in FIG. 1A. One such technique involves coupling separate hardware components corresponding to processor 150, communications sections 154, 156 and 158, memory 152, short-range input device 166, user interface 160, transponder 168, etc. through one or more bus interfaces (which may be wired or wireless bus interfaces). Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 160 may interact with a communication utilities software component, also contained in memory 152, which provides for the establishment of service sessions using long-range communications 154 and/or short-range communications 158. The communication utilities component may include various routines that allow the reception of services from remote devices according to mediums such as the Wireless Application Medium (WAP), Hypertext Markup Language (HTML) variants like Compact HTML (CHTML), etc.

### II. Device Pairing

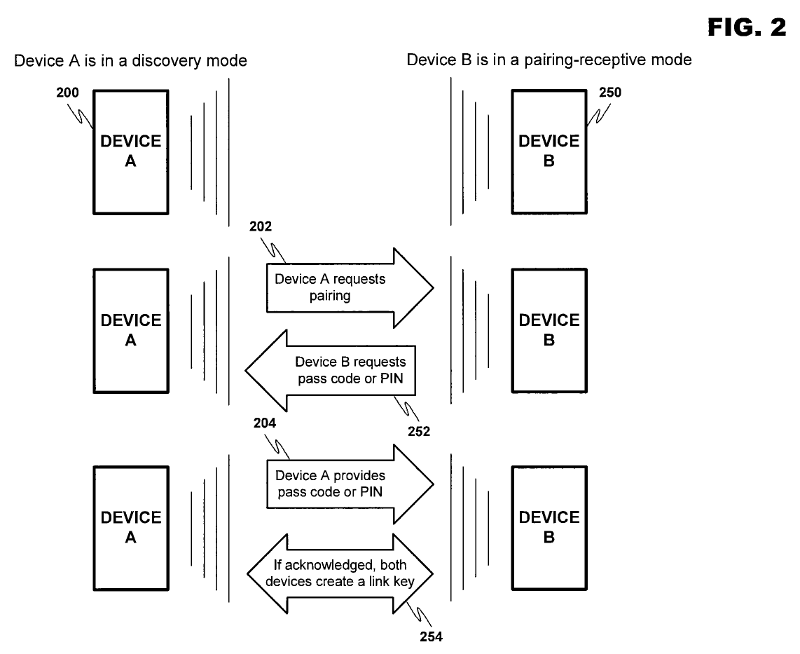

Now referring to FIG. 2, an example of a device “pairing” process is disclosed. “Pairing” is a term that may typically be associated with Bluetooth™ wireless communication. However, while Bluetooth™ has been used for the sake of explanation in this disclosure, the present invention is not limited in its application to only this particular wireless communication medium. Instead, various embodiments of the present invention may be applicable to any wireless communication medium including similar features or operations as described herein, such as wireless universal serial bus (wUSB), ultra wideband (UWB), etc.

Pairing, in accordance with at least one embodiment of the present invention, is the joining of at least two wireless communication devices in a known relationship wherein after the initial link establishment is completed, private or secret keys may be stored on each of the wireless devices to facilitate expedited link establishment in subsequent connections. In FIG. 2, device A 200 and device B 250 may be communicating via a wireless communication medium such as Bluetooth™. Prior to this process, these two devices may have never been used together, and therefore, may not be known to each other. Device A 200 is operating in a discovery mode. This mode may allow a WCD to search within effective wireless communication range for other devices that are currently configured to engage in a pairing process. Device B 250 may be operating in a pairing receptive mode. This type of mode may include a discovery mode, wherein a master-slave relationship is negotiating upon establishing the link. Otherwise, device B 250 may operate in a mode that does not engage other devices but merely awaits link requests.

In this example, device A 200 may issue a pairing request to device B 250 as shown at 202. This pairing request may include information such as device identification (e.g., BD_ADDR in Bluetooth) and device capability. If device B 250 is not screening from accepting communication from device A 200, for example due to a filter or internal rule, then device B 250 may respond, as shown at 252 by requesting a pass code or PIN from device A 200. For simple devices (e.g., a headset), the pass code or PIN may be hard coded in the device and readable by the user via indicia attached the device casing (e.g., a label). In more complicated devices, the pass code or PIN may be established via user configuration. The pass code pertaining to device B 250 may then be entered into device A 200 (e.g., via user interface 160), and device A 200 may summarily transfer this information to device B 250 as shown at 204. If this information is recognized by device B 250, both devices may use this information, along with other information like device identification, to create common keys, at 254, usable by the devices when connecting. These stored access keys may expedite future connection establishment for the “paired” devices.

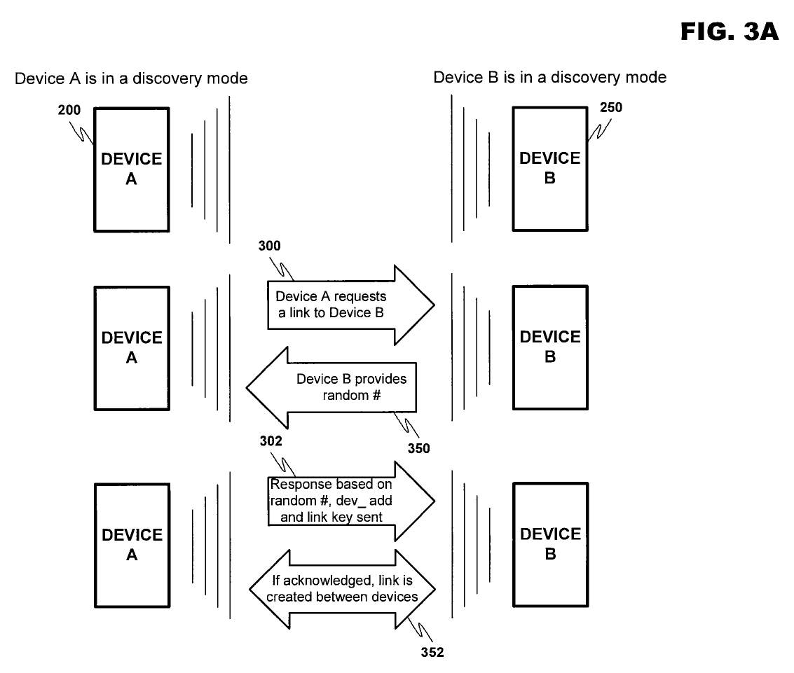

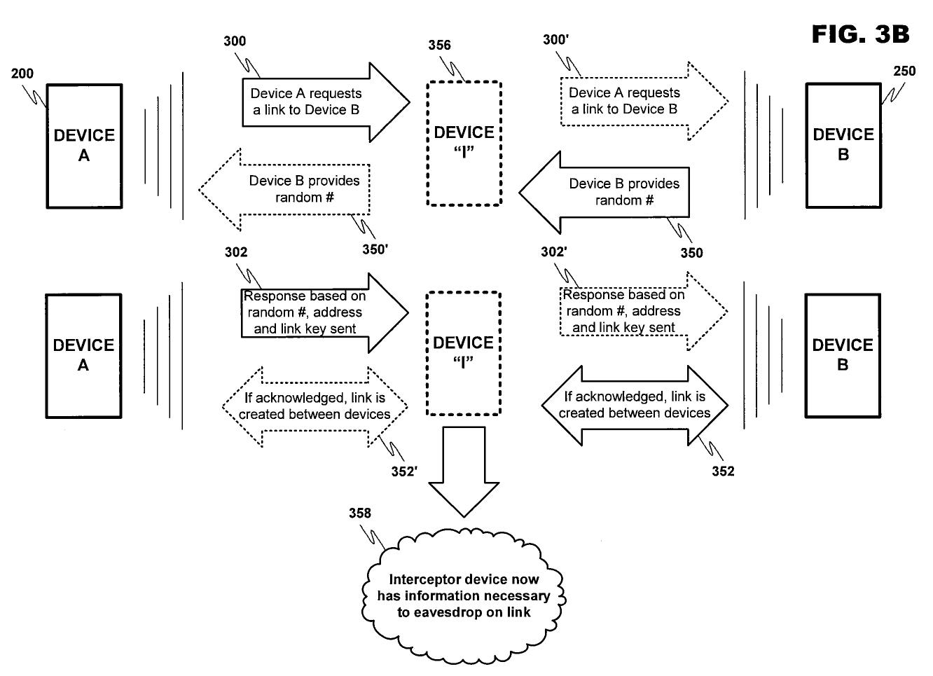

Once the common access keys are established and the devices are “paired”, then expedited link establishment may occur. FIG. 3A demonstrates an exemplary wireless linking process between paired devices. Device A 200 may request a connection to device B 250 at 300. The link process may then proceed through a “challenge-response” scheme in order to verify device identity. For example, device B 250 may provide a random number to device A 200 at 350. This random number may then be utilized by device A 200 to create a response that is computed using information such as the device identification (e.g., dev_addr in FIG. 3A), the random number and the link key previously determined during the pairing process. This response may be sent to device B 250 at 302. Device B 250 may then use the identification information for device A 200 at the random number it originally provided to extract the access key from the response. If the private access key derived from the response of device A 200 matches the corresponding private access key stored in device B 250, then the devices are recognized as having been previously paired and a wireless link may be established at 352.

However, this process inherently involves risk as another device may monitor the information flowing from device A 200 to device B 250, and as a result, gain access to one or both devices. An example of this process is disclosed in FIG. 3B. In this scenario, an intervening or “I” device 356 receives information from device A 200 and forwards the information to device B 250. This exemplary “man-in-the-middle” strategy is but one type of mischievous or malicious attack that may be perpetrated on an unsuspecting user. As before, messages 300 and 302 are sent from device A 200 to device B 250. However, device 1356 acts as an intermediary, storing the information in messages 300 and 302, and forwarding this information along to device B 250 as messages 300′ and 302′. As a result, device B 250 may assume that this information came directly from device A 200, and may be unaware that any other device is monitoring this transaction.

Similarly, device I 356 may also monitor wireless messages sent from device B 250 to device 200 A. In this example, messages 350 and 352 may first be received and stored by device I 356, and then forwarded to device A 200 as disclosed at 350′ and 352′. After the transaction is complete, device I 356 may have the information required to impersonate either device A 200 or device B 250, and as a result, may be able to establish a simulated “paired” connection with one or both devices. This fake paired connection may enable device 1356 to obtain personal or confidential information from these devices, or on the other hand, convey fraudulent or even damaging information (e.g., a virus) to either device A 200 or device B 250.

### V. Diffie-Hellman

In order to combat behaviors such as the example shown in FIG. 3B, developers are attempting to now employ more secure keying strategies. For instance, if it were possible to conceal at least some information that would be crucial for establishing a paired connection, then it would not matter whether another device, such as device 1356, were monitoring the link.

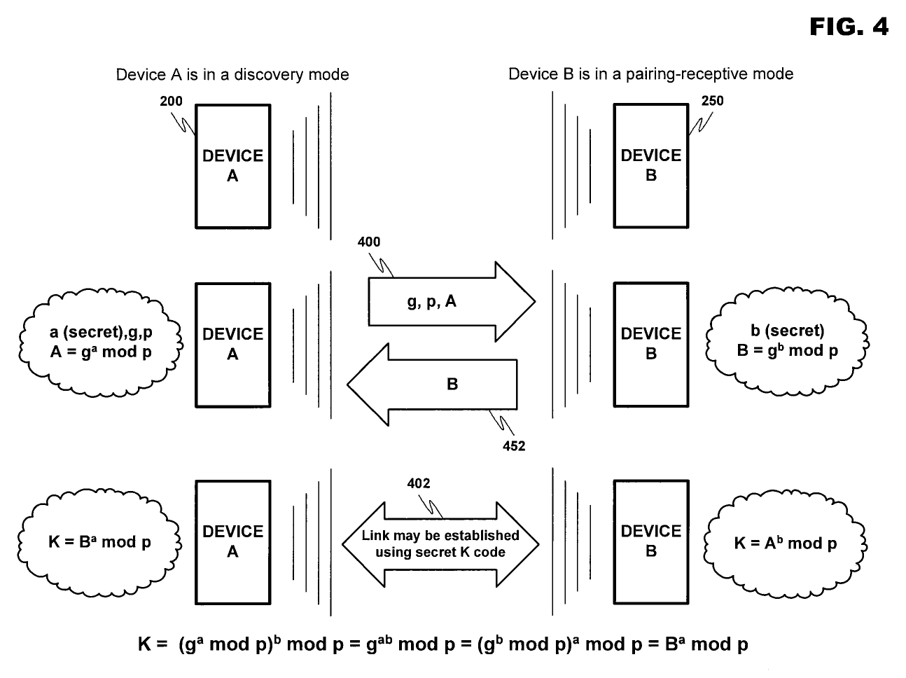

FIG. 4 discloses a more secure pairing strategy in accordance with the Diffie-Hellman key establishment theory. In such a strategy, both devices may calculate encrypted keys based on an algorithm which may be interpreted by the other device in order to determine a common key value. However, not all of the values are determinable simply by monitoring the transmissions because both devices, for example device A 200 and device B 250 have individual and distinct secret values (e.g., a and b as will be explained further below). For example, the protocol has two system parameters p and g. They are both public and may be used by all the users in a system. Parameter p is a prime number and parameter g (usually called a generator) is an integer less than p, with the following property: for every number n between 1 and p−1 inclusive, there is a power a of g such that A=g^{a} mod p. The values of g, p and A, once calculated may be sent from device A 200 to device B 250 such as shown at 400 in FIG. 4.

Further, device B may receive the values of g, p and A sent by device A 100 and use these values to calculate B. B may be calculated using these values as follows: B=g^{b} mod p. The value of B may then be sent back to a device A 200 at 452. A common key K may then be calculated between the devices based on the following relationships: K=(g^{a} mod p)^{b} mod p=g^{ab} mod p=(g^{b} mod p)^{a} mod p=B^{a} mod p. Therefore, K can be calculated as shown at 402 in both device A 200 and device B 250 without ever transferring the secret values a and b to the other device. Without these secret values, an eavesdropping device cannot calculate K, and as a result, may not gain access to either device A 200 or device B 250 via an impersonation attack.

However, a key security strategy such as the Diffie-Hellman-based key strategy shown in FIG. 4 may also preclude transaction monitoring for beneficial exploits. For example, hardware and/or application developers may want to employ monitoring devices to track sent and received messages when “debugging” or trouble-shooting new products or solving existing communication problems. Therefore an operational mode may need to be available that will override the key encryption as shown in FIG. 4 so that inter-device transactions may be studied.

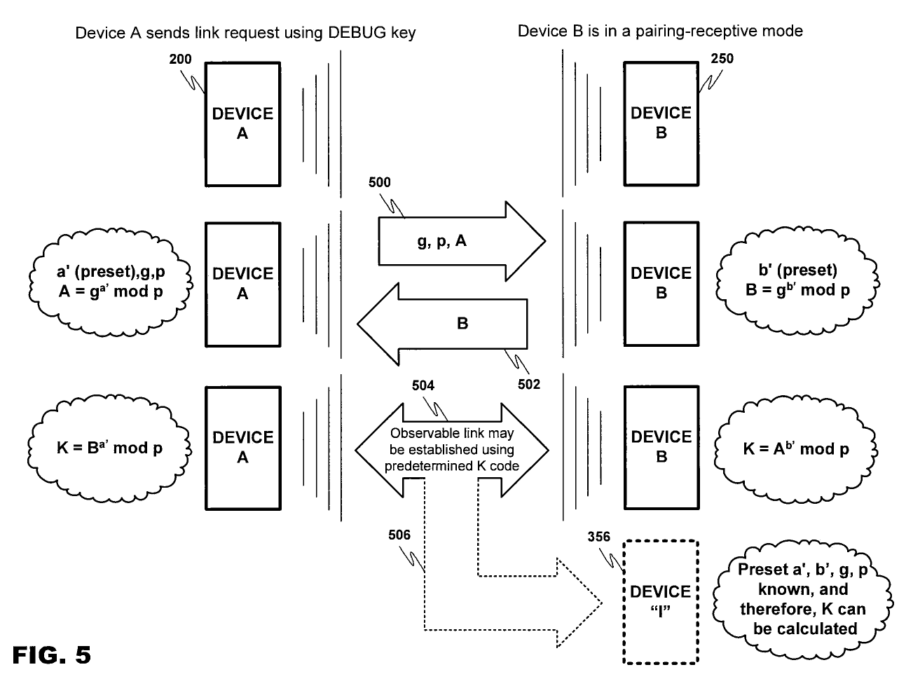

FIG. 5 discloses an example of how to force a Diffie-Hellman-based key strategy into a mode where monitoring may occur. Either device A 200 or device B 250 may be set in a debug mode through the establishment of a wireless link using the predetermined link key information, however, in this example device A 200 is initiating the debug link. The link may be established, wherein the values for a and b that were previously secret (e.g., known only to each individual device) may now be predetermined. For example a′ and b′ as shown in FIG. 5 may be defined by a standard corresponding to the particular wireless communication medium. Otherwise, the key establishment may proceed similarly to the example shown in FIG. 4. In this scenario, g, p and A may again be conveyed by device A 200 to device B 250 at 500, and device B 240 may respond by sending the value of B to device A 200 at 502. Both of these devices may use these values to compute K, which is the common key usable to link the two devices together.

However, in this example since a′, b′, g and p are established, for example, by the particular communication medium being used, another device may use these same values to establish its own key (K) and monitor communications between device A 200 and device B 250. In a controlled situation, such as a laboratory or in a technical support environment, establishing this “unsecured” link may be desirable in order to pursue beneficial transaction monitoring and problem solving. However, as shown at 506 in FIG. 5, if this mode were activated on either device A 200 or device B 250 through the exploits of “man-in-the-middle” device 1356, then the safeguards realized by the use of a Diffie-Hellman-based key strategy may be nullified.

### VI. Protective Strategies for Guarding Against Debug Mode Misuse

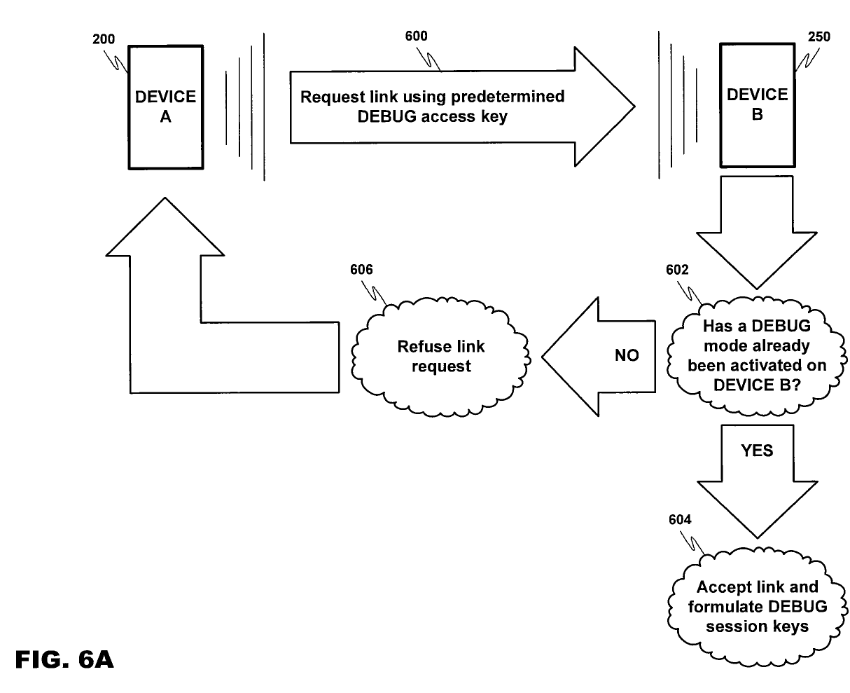

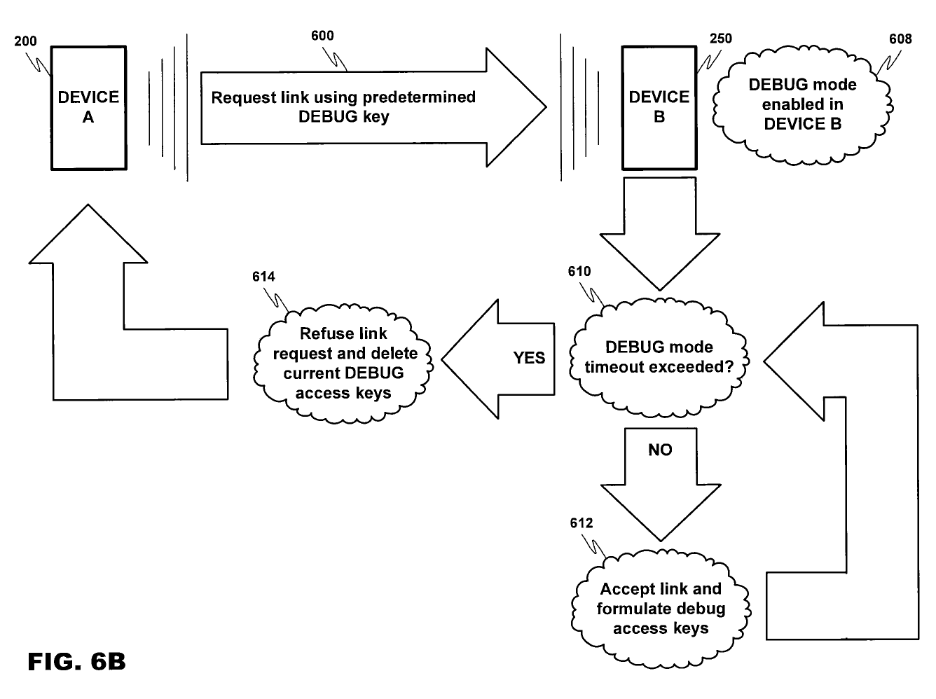

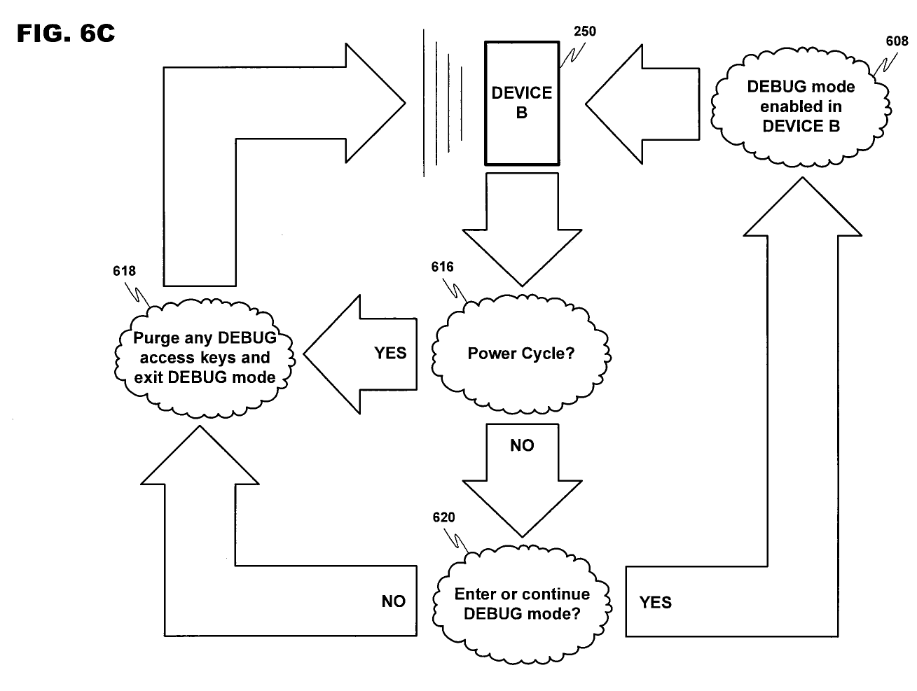

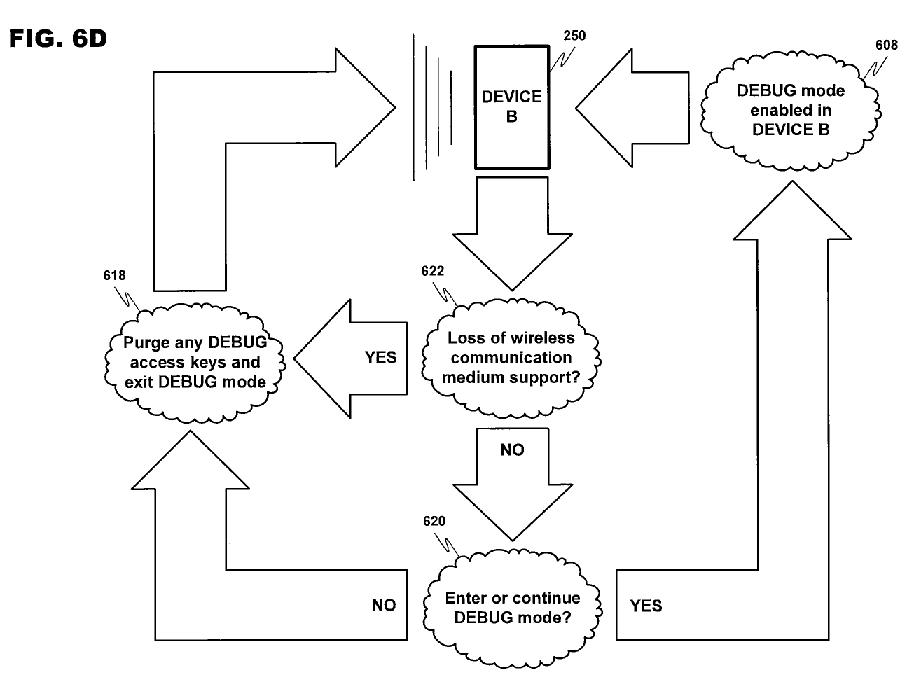

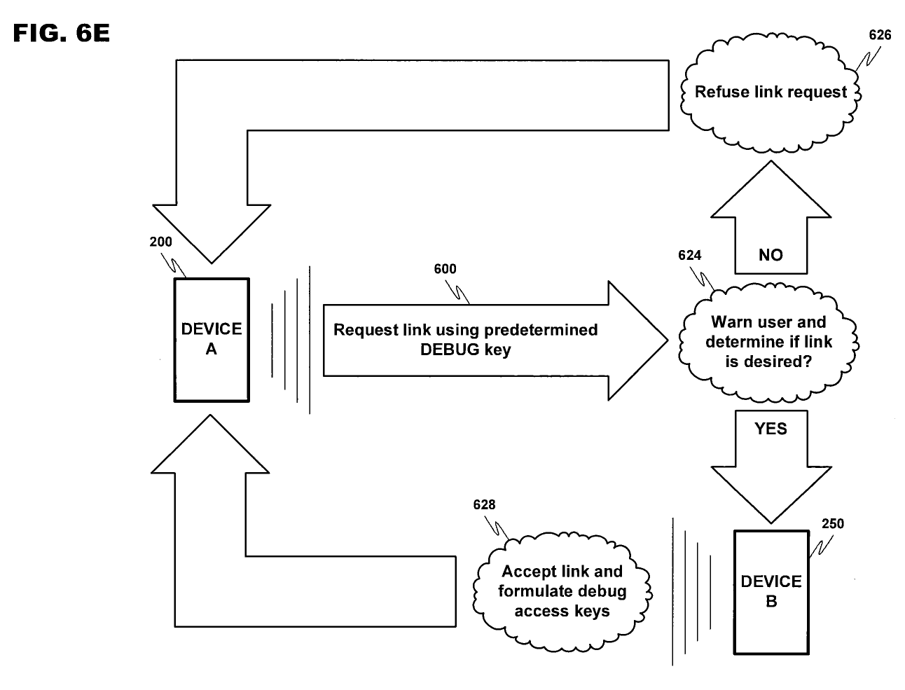

FIG. 6A discloses a protective strategy that may be employed in accordance with at least one embodiment of the present invention. For example, device A 200 may initiate wireless link establishment to device B 250 at 600 using predetermined debug key information. However, safeguards have now been incorporated in device B 250, wherein a determination is first performed in order to verify whether device B 250 was already operating in debug mode before accepting the request to establish a wireless link to the other device. More specifically, this verification may determine whether device B 250 was already set into a debug mode, for example, through manual interaction using user interface 160 on device B 250. Therefore, in this example if device B 250 was already set in a debug mode, then debug link establishment, and the establishment of debug access keys corresponding to the particular requesting device (e.g., device A 200) may be created as shown at 604. However, if debug mode has not already been established when checked at 602, then at 606 device B 250 may refuse the request for link establishment from device A 200, and may in some instances, further notify device A 200 that the link has been denied due to a debug mode security condition existing on device B 250.

In an alternative configuration in accordance with at least one embodiment of the present invention, a predetermined timeout may be employed to ensure that a user does not leave their WCD (e.g., device B 250) in a debug mode by accident. For example, in FIG. 6B a request is again sent from device A 200 to device B 250 at 600. This message may include a request for link establishment using predetermined debug key information. Device B 250 may, if already in a debug mode, reference a counter or timer to determine the duration of the current debug mode. Device B 250 may maintain debug mode, accept the request to create the wireless link, and formulate any access keys required to maintain this link with device A 200, at 612 until the timer in device B 250 exceeds a timeout limit. When the timer value exceeds the duration limit set in the device (e.g., as determined at 610) then device B 250 may exit debug mode, refuse a new link or end a current link with device A 200, and may further delete any keys created to support the terminated link. In this manner, device B 250 may include safeguards against being left in an unprotected mode. This process may further include a visual or audio inquiry (not shown) to the user verifying if the debug mode should be deactivated when the timer has achieved the timeout value, or whether the timer should be reset, disabled, etc. In this way, the user of device B 250 may decide whether to allow the deactivation to occur at the timeout, or whether to continue operation in debug mode, allowing for a case where beneficial debug mode use is occurring.

FIG. 6C discloses an example of a security strategy where device B 250 checks to determine whether power has been cycled (e.g., has the device been turned from on to off and on again) in device B 250 in order to maintain a secure operating condition. It is important to note that this process may occur at any time, and therefore, does not need to be triggered by an inquiry from another device such as device A 200. At 616, device B 250 may verify whether power has been cycled in the device. If the power has not been cycled, then at 620 device B 250 may perform a further inquiry as to whether to enter or continue a debug mode. The decision to enter or continue a debug mode may come from, for example, manual activation by the user of device B 250. If debug mode should be activated or continued at 620, then it is enabled at 608. However, if activation is not needed or desired, then at 618 any debug keys remaining from previous links to other devices (e.g., device A 200) may be deleted or purged, and the process returns to 250. Otherwise, if power cycling is detected at 616, then at step 618, device B 250 exits debug mode (if currently in debug mode) and, as stated above, any debug keys remaining from previous links to other devices (e.g., such as device A 200) may be deleted or purged.

Along with determining whether a timer has exceeded a predetermined duration and monitoring whether power has been cycled, device B 250, in accordance with at least one embodiment of the present invention, may also monitor whether support for a particular wireless communication medium has been disabled or discontinued. Similar to the strategy of FIG. 6C, it is important to note that this process may occur at any time, and therefore, does not need to be triggered by an inquiry from another device such as device A 200. At 616, device B 250 may verify whether support has been discontinued for a particular wireless communication medium (e.g., a wireless communication medium that is currently supporting a debug mode wireless link). If the wireless communication medium continues uninterrupted, then at 620 device B 250 may perform a further inquiry as to whether to enter or continue a debug mode. The decision to enter or continue a debug mode may come from, for example, manual activation by the user of device B 250. If debug mode should be activated or continued at 620, then it is enabled at 608. However, if activation is not needed or desired, then at 618 any debug keys remaining from previous links to other devices (e.g., such as device A 200) may be deleted or purged, and the process returns to 250. Otherwise, if the discontinuation of support for a particular wireless communication medium is detected at 622, then at step 616, device B 250 exits debug mode (if currently in debug mode) and, as stated above, any debug keys remaining from previous links to other devices (e.g., such as device A 200) may be deleted or purged.

FIG. 6E discloses an exemplary configuration of the present invention, in accordance with at least one embodiment, wherein an inquiry to the user as to whether to continue debug mode is issued. Initially, device A 200 may request that device B 250 establish a wireless link using debug key information at step 600. Upon sensing the request for link establishment (e.g., 600) device B 250 may display an inquiry to the user at 624, for example via user interface 160, asking whether to allow a wireless link to be established to device A 200. In some instances the notification at 624 may be phrased more as a warning so that a user may understand that granted both the link establishment and mode change may jeopardize the security of device B 250. Once the user reads the notification, he/she may decide to accept the mode change and/or link establishment or refuse it. If these options are accepted (e.g., through a key press), then debug mode may be activated (if required) at 628 and the link request from device A 200 may be accepted, along with the formulation of any access keys corresponding to device A 200. However, if the user heeds the warning and determines that device integrity may be jeopardized by allowing the debug mode entry and/or link establishment, then in step 626 the link establishment request from device A 200 may be refused. In some instances, a wireless notification may also be sent to device A 200 advising that the request at 600 has been denied due to, for example, security rules established on device B 250. While not pictured, after a user originally refuses to accept link establishment from device A 200, the inquiry may repeat as new requests to establish links are received. Further, the two requests may not be mutually exclusive, wherein, for example, a user may permit link establishment without entering debug mode.

Accordingly, it will be apparent to persons skilled in the relevant art that various changes in form a and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
establishing communication on a wireless communication interface;
receiving one or more messages including at least key information;
determining whether the key information includes key information related to a reduced security mode;
if the key information includes reduced security mode key information, verifying whether communication in a reduced security mode is allowed; and
triggering an event based on the verification.

2. The method of claim 1, wherein verifying whether communication in a reduced security mode is allowed includes determining whether a device is already operating in a reduced security mode.

3. The method of claim 2, wherein verifying whether communication in a reduced security mode is allowed includes determining a duration of time that a device has already been operating in a reduced security mode.

4. The method of claim 3, wherein verifying whether communication in a reduced security mode is allowed includes determining whether the duration of time has exceeded a predetermined limit.

5. The method of claim 1, wherein verifying whether communication in a reduced security mode is allowed includes obtaining permission from a user of a device user through a user interface.

6. The method of claim 1, wherein triggering an event includes continuing communication in a reduced security mode.

7. The method of claim 6, wherein any locally stored reduced security key information is deleted as a result of termination of the communication.

8. The method of claim 1, wherein triggering an event includes refusing to continue the communication.

9. The method of claim 1, wherein triggering an event includes exiting a reduced security mode.

10. The method of claim 1, wherein triggering an event includes deleting locally stored reduced security key information corresponding to the most recent reduced security communication.

11. The method of claim 1, wherein triggering an event includes two or more of refusing to continue communication, exiting a reduced security mode, and deleting locally stored reduced security key information corresponding to the most recent reduced security communication.

12. The method of claim 1, further comprising one or more of refusing to continue communication, exiting a reduced security mode, and deleting locally stored reduced security key information corresponding to the most recent reduced security communication whenever power is cycled.

13. The method of claim 1, further comprising one or more of refusing to continue communication, exiting a reduced security mode, and deleting locally stored reduced security key information corresponding to the most recent reduced security communication whenever the wireless communication interface is deactivated.

14. The method of claim 1, wherein the reduced security mode includes a debug mode.

15. A computer program product comprising a computer usable medium having computer readable program code embodied in said medium, comprising:
a computer-readable program code configured to establishing communication on a wireless communication interface;
a computer-readable program code configured to receive one or more messages including at least key information;
a computer-readable program code configured to determine whether the key information includes key information related to a reduced security mode;
a computer-readable program code configured to, if the key information includes reduced security mode key information, verify whether communication in a reduced security mode is allowed; and
a computer-readable program code configured to trigger an event based on the verification.

16. The computer program product of claim 15, wherein verifying whether communication in a reduced security mode is allowed includes determining whether a device is already operating in a reduced security mode.

17. The computer program product of claim 16, wherein verifying whether communication in a reduced security mode is allowed includes determining a duration of time that a device has already been operating in a reduced security mode.

18. The computer program product of claim 17, wherein verifying whether communication in a reduced security mode is allowed includes determining whether the duration of time has exceeded a predetermined limit.

19. The computer program product of claim 15, wherein verifying whether communication in a reduced security mode is allowed includes obtaining permission from a user of a device user through a user interface.

20. The computer program product of claim 15, wherein triggering an event includes continuing communication in a reduced security mode.

21. The computer program product of claim 20, wherein any locally stored reduced security key information is deleted as a result of termination of the communication.

22. The computer program product of claim 15, wherein triggering an event includes refusing to continue the communication.

23. The computer program product of claim 15, wherein triggering an event includes exiting a reduced security mode.

24. The computer program product of claim 15, wherein triggering an event includes deleting locally stored reduced security key information corresponding to the most recent reduced security communication.

25. The computer program product of claim 15, wherein triggering an event includes two or more of refusing to continue communication, exiting a reduced security mode, and deleting locally stored reduced security key information corresponding to the most recent reduced security communication.

26. The computer program product of claim 15, further comprising one or more of refusing to continue communication, exiting a reduced security mode, and deleting locally stored reduced security key information corresponding to the most recent reduced security communication whenever power is cycled.

27. The computer program product of claim 15, further comprising one or more of refusing to continue communication, exiting a reduced security mode, and deleting locally stored reduced security key information corresponding to the most recent reduced security communication whenever the wireless communication interface is deactivated.

28. The computer program product of claim 15, wherein the reduced security mode includes a debug mode.

29. A device comprising:
at least one wireless communication module; and
a processor coupled to the at least one wireless communication module, the processor further being configured to:
establish communication on a wireless communication interface;
receive one or more messages including at least key information;
determine whether the key information includes key information related to a reduced security mode;
if the key information includes reduced security mode key information, verify whether communication in a reduced security mode is allowed; and
trigger an event based on the verification.

30. The device of claim 29, further including at least one user interface for conveying a user-interpretable message regarding the reduced security mode.

31. The device of claim 29, wherein the reduced security mode includes a debug mode.

32. A device, comprising:
means for establishing communication on a wireless communication interface;
means for receiving one or more messages including at least key information;
means for determining whether the key information includes key information related to a reduced security mode;
means for, if the key information includes reduced security mode key information, verifying whether communication in a reduced security mode is allowed; and
means for triggering an event based on the verification.

33. The device of claim 32, further including at least one user interface for conveying a user-interpretable message regarding the reduced security mode.

34. The device of claim 32, wherein the reduced security mode includes a debug mode.

35. A system, comprising:
a first device; and
a second device;
the first device and the second device establishing communication on a wireless interface, the communication comprising one or more messages including at least key information;
the first device determining whether the key information includes key information related to establishing communication in a reduced security mode, and if the key information includes reduced security mode key information, verifying whether communication in a reduced security mode is allowed; and
the first device triggering an event based on the verification.
